(19) United States
(12) Patent Application Publication
(10) Pub. No.: US 2015/0323172 A1
(43) Pub. Date: Nov. 12, 2015

(54) Candle and Oil Lamp Holder Interface

(71) Applicant: Yonah Singer, Lakewood, NJ (US)

(72) Inventor: Yonah Singer, Lakewood, NJ (US)

(21) Appl. No.: 14/271,531

(22) Filed: May 7, 2014

(51) Int. Cl. F21V 35/00; B23P 19/00

(52) U.S. Cl. CPC F21V 35/003; B23P 19/00

(57) ABSTRACT

Embodiments of the disclosed technology are directed to devices and/or methods for securely engaging a candle-holding receptacle or oil lamp within a candle holder. The devices and/or methods may employ a candle holder interface which is formed of a unitary body having male and female ends, with a flange there-between. The male end is adapted to be inserted into a candle holder. The female end is adapted to receive a candle-holding receptacle or oil lamp. The interface securely holds the candle-holding receptacle or oil lamp within the candle holder and/or catches any excess oil that drips from the burning portion of the wick.

### FIELD OF THE DISCLOSED TECHNOLOGY

The disclosed technology relates generally to candles and oil lamps, and more particularly to an interface used between a smaller, candle-holding receptacle (or oil lamp) and a larger, supporting candlestick, candelabra or other candle holder.

### BACKGROUND OF THE DISCLOSED TECHNOLOGY

Candles and oil lamps are still commonly used today in religious ceremonies, or to provide accent or emergency lighting. Candles are typically formed of a solid cylindrical block of wax, with an embedded wick which is ignited to provide light. Similarly, oil lamps use a hollow receptacle filled with liquid fuel, with a wick extending therefrom. Candles and oil lamps are typically placed into a candle holder or chandelier for decoration and other purposes.

A common problem associated with a wax candle placed in a candle holder is the residue of melted wax. As the wick burns, excess melted wax often drips down and attaches itself to the sides of the candle. The wax may drip and harden on the candle holder, the buildup of which may be unsightly and obstructive. In addition, the re-hardening wax may fall onto surrounding surfaces and objects. To alleviate this problem, candles are often placed in small, candle-holding receptacles, which are often disposable. The candle-holding receptacles are made to hold the candles and catch any dripping wax. These candle-holding receptacles are then placed in larger, candlesticks or candelabras which are designed to hold both the candle and receptacle. However, this poses another problem, as the candle and its receptacle may not sit securely within the supporting candlestick or candelabra, and are prone to being accidentally knocked out of the supporting candlestick or candelabra, or otherwise falling out, causing a fire.

Oil lamps may alleviate the problem of unwanted dripping excess wax. However, many oil lamps are not shaped to properly sit in a traditional candle holder because these lamps typically are formed of a rigid outer body which may not fit securely in a candle holder. Therefore, as a candle replacement, oil lamps may not be suitable because they do not fit properly within a candle holder. If the oil lamps are not secured within the candle holder, a possible hazard exists, in that the lamp is susceptible to falling out of the holder and causing a fire. Thus, there is a need in the art for a candle or oil lamp holder interface which securely holds a candle-holding receptacle or an oil lamp in a traditional candle holder.

### SUMMARY OF THE DISCLOSED TECHNOLOGY

Therefore, it is an object of the disclosed technology to provide a candle and oil lamp holder interface for securing a candle-holding receptacle or oil lamp within a recess of a candle holder.

In an embodiment of the disclosed technology, a candle holder interface is provided. The candle holder interface employs a substantially circular male end having an outer radius shorter than that of a radius of the candle holder. A substantially circular female end is disposed on a side opposite the male end, having an inner radius greater than that of a terminal receptacle adapted for being mated at a mating surface of the female end. A “female end” is defined as any extremity or end portion of the candle holder interface into which a corresponding male end or other insertable portion of an object may be received. A “male end” is inversely related to the “female end” in that it is defined as any extremity or other portion of an object which is insertable into a receiving female end, recess, or candle holder.

Further, a circular flange is situated between, and forming a unitary body with, the male end and the female end, wherein the circular flange has an outer radius greater than that of the outer radius of the male end and the outer radius of the female end. A “flange” is defined as a flat, horizontal lip extending circumferentially around an exterior of the candle holder interface and generally occupying a single horizontally disposed plane. A “terminal receptacle” is defined as any narrow or tapered insertable base which is disposed on a terminal end of a receptacle of a light producing object, such as a candle-holding receptacle or oil lamp. The terminal end of the object is the bottom end with respect to the force of gravity.

In a further embodiment of the disclosed candle holder interface, the mating surface of the female end has an outer lip extending above a generally flat and substantially circular female end. The outer lip is pressed tightly against the underside of an oil lamp, in embodiments of the disclosed technology, thus forming a tight seal around the underside of the oil lamp. This prevents oil from spilling into the female end of candle holder interface, which would prevent it from holding the oil lamp securely. The “female mating surface” is defined as the lowermost surface of the female end which will abut a corresponding male mating surface when mated. Still further, the mating end may be flexible, and also may frictionally engage with the terminal receptacle forming a continuous or nearly continuous (defined as “at least 80% in contact with”) outer surface between the outer lip and the terminal receptacle. The terminal receptacle may be an oil lamp having a male connecting end and a cylindrical oil housing, wherein, further, the male end frictionally engages with the female end of the candle holder interface, such that the cylindrical oil housing abuts an entire circumference of the outer lip of the candle holder interface. It should be understood that the terms “candle holder interface” and “oil holder interface” are used interchangeably in this document.

In still a further embodiment of the disclosed candle holder interface, the bottom surface of the circular flange and/or the male end of the candle holder interface may be at least partially coated with a pliable adhesive filler, forming fixed and removable engagement with the candle holder into which the candle holder interface is placed. Further, a portal may extend through the circular male end, the female end, and the outer lip. “Portal”, for purposes of this specification, is defined as a hollow void extending at least partially through said candle holder interface between the male end and the female end.

In another embodiment of the disclosed technology, a method is used for holding a candle-holding receptacle. A first step of the method is carried out by receiving a base of the candle-holding receptacle into a substantially circular female end of a candle holder interface. The substantially circular female end may be on a side of the interface opposite a substantially circular male end on the candle holder interface. Further, the interface may have a circular flange situated between, and forming a unitary body with, the female end and the male end. The circular flange may have an outer radius greater than that of an outer radius of the male end and an outer radius of the female end.

A next step of the method may be carried out by inserting the male end of the candle holder interface into a candle holder such that the bottom surface of the flange with the adhesive abuts a rim of the candle holder. A “rim of the candle holder” is defined as the uppermost portion of the candle holder having a circular shape and defining a circular void therein. A further step may be provided of partially coating a bottom surface of the circular flange and/or the male end of the candle holder interface with a pliable adhesive filler. The adhesive may be pre-applied before shipping the product or applied by a user just before use. This step may be carried out before the step of inserting the male end of the candle holder interface into the candle holder. The female end may have spaced-apart projections disposed near a top portion thereof for frictionally holding the base of the candle-holding receptacle or oil lamp in place.

It should be understood that the use of “and/or” is defined inclusively such that the term “a and/or b” should be read to include the sets: “a and b,” “a or b,” “a,” “b.” Further details are set forth in the detailed description below. It should further be understood that, for purposes of this specification, “substantially” is defined as, “what an ordinary observer would consider it to be” or “within a 5% tolerance level of being so.” Thus, for example, “substantially circular” is defined as “what an ordinary observer would consider to be a circle” or “within 5% of a true circle.” When a term is modified by “substantially,” it is defined as being “within a tolerance level accepted within the art.” For example, a “flat” base is accepted as “flat” if an ordinary person skilled in the art of candle holders would consider it to be so.

### BRIEF DESCRIPTION OF THE DRAWINGS

FIG. 1 shows a top perspective view of a candle holder interface of an embodiment of the disclosed technology.

FIG. 2 shows a side elevation view of a candle holder interface of an embodiment of the disclosed technology.

FIG. 3 shows a top plan view of a candle holder interface of an embodiment of the disclosed technology.

FIG. 4 shows a bottom perspective view of a candle holder interface of an embodiment of the disclosed technology.

FIG. 5 shows a side elevation view of a glass candle holder and a candle holder interface for receiving the oil lamp, according to an embodiment of the disclosed technology.

FIG. 6 shows a partial cutaway side view of the glass candle holder and candle holder interface of FIG. 5.

FIG. 7 shows a top perspective view of another candle holder interface of an embodiment of the disclosed technology.

FIG. 8 shows a side elevation view of the candle holder interface of FIG. 7.

FIG. 9 shows a bottom perspective view of the candle holder interface of FIG. 7.

FIG. 10 shows a side elevation view of an oil lamp, a candle holder interface, and a candle holder, according to an embodiment of the disclosed technology.

FIG. 11 shows the oil lamp inserted into the candle holder interface of FIG. 10.

FIG. 12 shows the oil lamp and candle holder interface of FIG. 11 inserted into the candle holder.

### DETAILED DESCRIPTION OF EMBODIMENTS OF THE DISCLOSED TECHNOLOGY

Embodiments of the disclosed technology are directed to devices and/or methods for securely engaging a candle-holding receptacle or oil lamp within a candle holder. The devices and/or methods may employ a candle holder interface which is formed of a unitary body having male and female ends, with a flange there-between. The male end is adapted to be inserted into a candle holder. The female end is adapted to receive a candle-holding receptacle or oil lamp. The interface securely holds the candle-holding receptacle or oil lamp within the candle holder and/or catches any excess oil that drips from the burning portion of the wick.

Embodiments of the disclosed technology will become clearer in view of the following description of the figures.

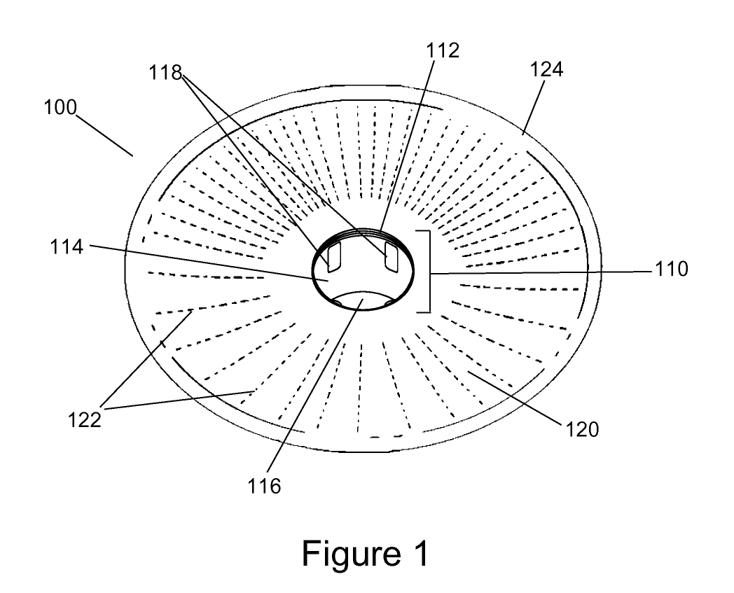

FIG. 1 shows a top perspective view of a candle holder interface of an embodiment of the disclosed technology. The candle holder interface 100 (herein “holder interface 100” or “interface 100”) is formed of a generally unitary and circular body. An interface 100 is defined as an intermediary device used for mating a candle-holding receptacle or oil lamp with a candle or oil lamp holder. The interface 100 has a gradually tapered flange 120. The flange 120 is defined as a substantially flat belt extending horizontally around an outer circumference of the interface 100. The flange 120 has an outer rim 124 residing at an outer radius of the flange. A substantially circular female recess 110 resides at a center of the interface 100. The female end or female recess 110 is defined as a hollow, circular void formed at a center portion of the interface 100. Lines 112 and 122 show how the flange gradually tapers downward into the opening 110 and has a concave shape. An interior side wall 114 of the female recess 110 is generally cylindrical, having one or more projections 118 for securing a base portion of an oil lamp or candle-holding receptacle within the recess 110. A bottom surface 116 of the female recess 110 provides a bottom extremity on which a candle-holding receptacle or oil lamp may rest.

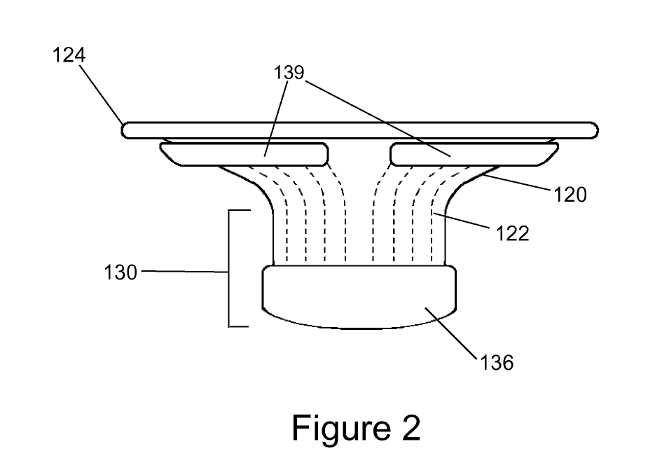

FIG. 2 shows a side elevation view of a candle holder interface of an embodiment of the disclosed technology. Depicted in this view is a male end 130 of the interface 100. The male end 130 is defined as an extremity that is substantially circular and fits into a receiving recess, such as, for example, an open portion of a candle holder. The male end 130 extends downward from the flange 120. The bottom of the male end 130 may have adhesive putty, or another malleable adhesive or form widener 136 having a greater diameter than the rest of the male end. The adhesive putty 136 may secure the interface 100 within a terminal receptacle of a candle holder. Further, adhesive 139 may secure the bottom side of the top portion of the interface to a candle holder.

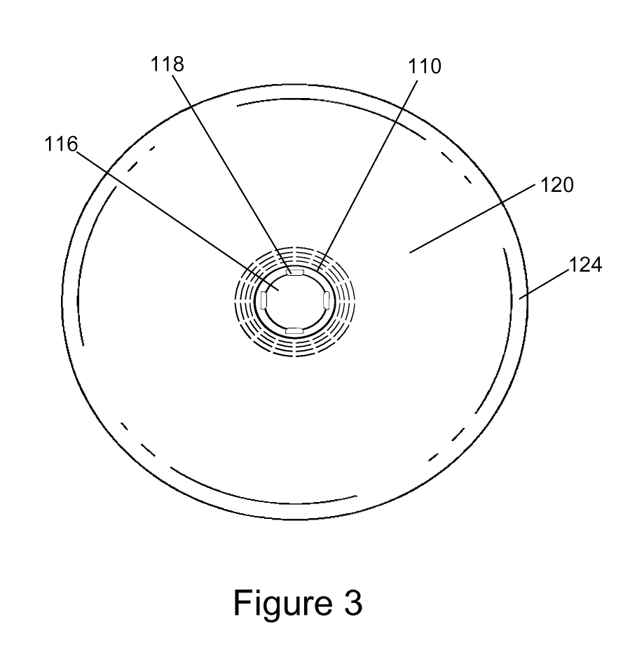

FIG. 3 shows a top plan view of a candle holder interface of an embodiment of the disclosed technology. From this view, side walls 114 of the female recess 110 are shown to be slightly tapered. The tapering facilitates the receiving of a candle-holding receptacle base or an oil lamp base within the recess 110. Projections 118 extending slightly from the walls 114 serve to hold the candle-holding receptacle or lamp base within the recess 110.

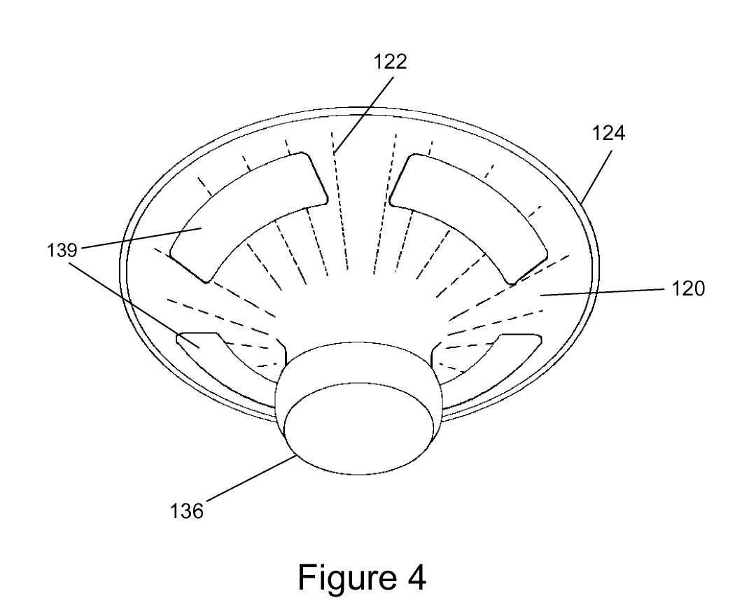

FIG. 4 shows a bottom perspective view of a candle holder interface of an embodiment of the disclosed technology. The tapered flange 120 terminates at the male end 130. Thus, the female recess 110 forms the interior of the male end 130. That is, essentially, these portions of the interface are formed by the same structure, with the male end 130 being inversely related to the female recess 110. Further, adhesive 139 may secure the bottom side of the top portion of the interface to a candle holder.

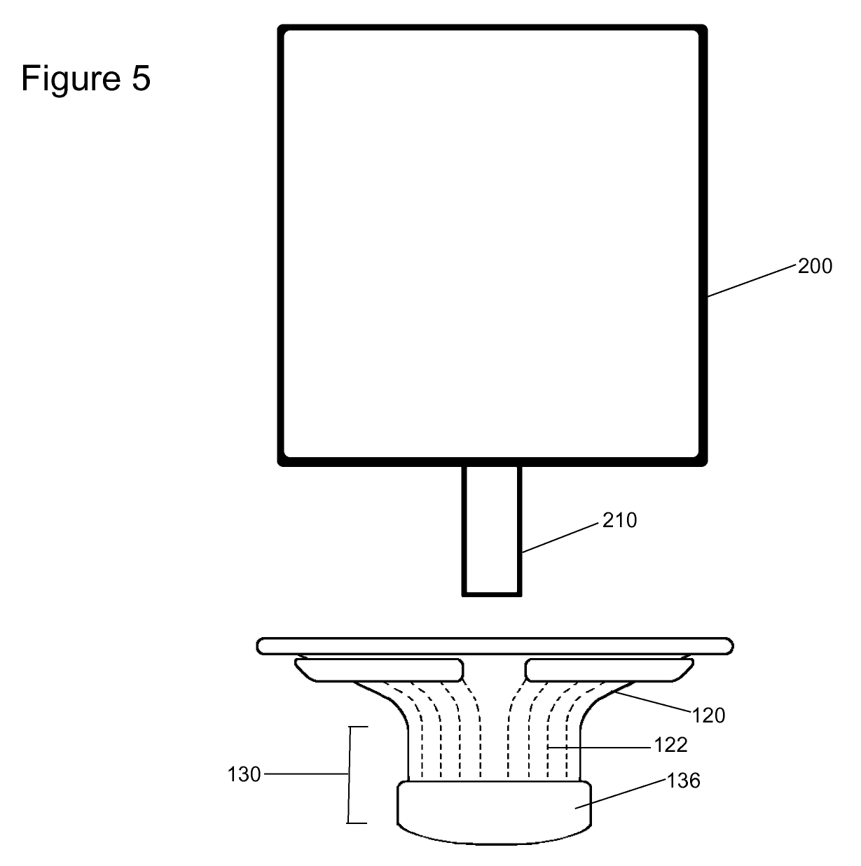

FIG. 5 shows a side elevation view of a glass candle holder and a candle holder interface for receiving the glass candle holder, according to an embodiment of the disclosed technology. The glass candle holder 200 may generally be formed of a hollow glass or plastic enclosure in which a candle may reside. Many glass candle holders have a narrow base portion 210 for seating the glass candle holder 200 within a traditional candle holder. The glass candle holder 200 is shown in a position above the candle holder interface 100.

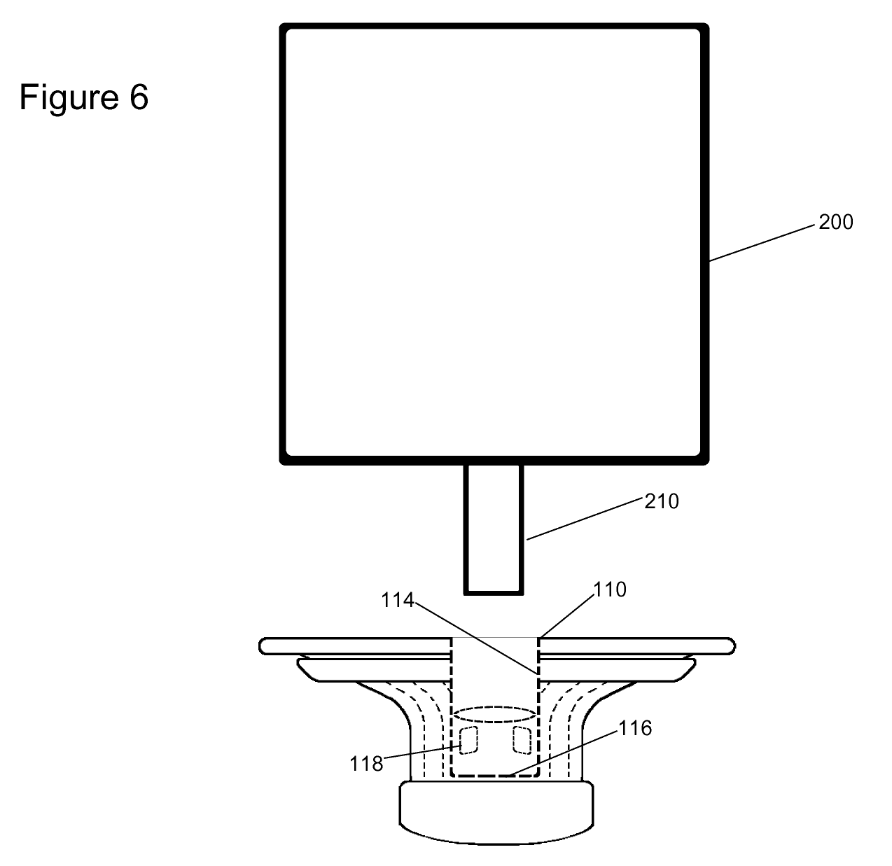

FIG. 6 shows a glass candle holder and a partial cutaway side view of the candle holder interface of FIG. 5. Here, the portion of the interface 100 directed to the female recess 110 is depicted. The lightly shaded dotted lines correspond to the projections 118 adapted to receive and snuggly hold the base portion 210 of the glass candle holder 200. In a method of carrying out embodiments of the disclosed technology, the base portion of the glass candle holder 200 would be inserted into the female recess 110.

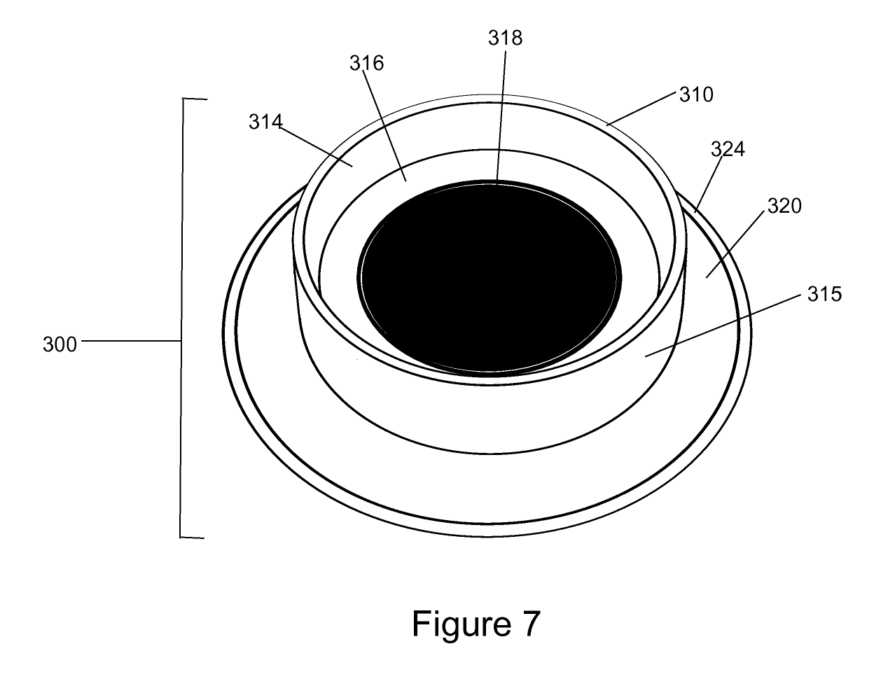

FIG. 7 shows a top perspective view of another candle holder interface of an embodiment of the disclosed technology. In the embodiment depicted, a candle holder interface 300 may be generally formed of a unitary body, with a recess 318 disposed therein. The recess 318 is defined as any hollow void which extends at least partially through a center axis of the interface 300. A flange 320 of the interface 300 in this embodiment may be generally flat and of a slightly larger radius than the outer radius of a female end 315 of the interface 300. The female end 315 is generally circular, having an interior wall 314 and a top rim 310. The interior wall 314 terminates at a bottom end at a flat inner mating surface 316 and further rises above the recess 318. The inner mating surface 316 having the recess 318 disposed at various positions circumferentially therein. The flange 320 may have an outer rim 324. The recess 318 may be disposed entirely through the interface 300, thereby resulting in a hollow center. The female end 315 and/or the recess 318 may receive an oil lamp therein.

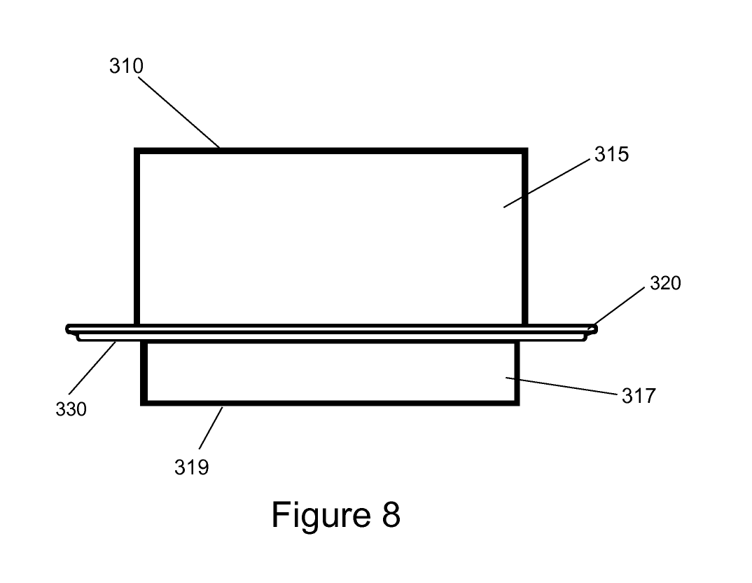

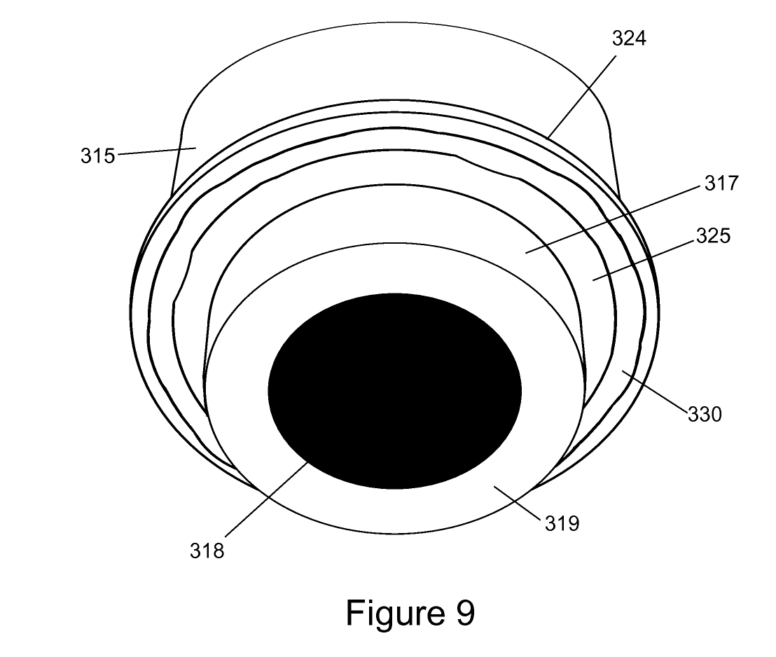

FIG. 8 shows a side elevation view of the candle holder interface of FIG. 7. A male end 317 is formed of a hollow cylindrical portion having an outer radius that is less than both the outer radii of the female end 315 and the flange 320. The flange 320 has a bottom surface (325. as labeled in FIG. 9), which, when applied to a candle holder, abuts an outer rim of the candle holder. A bottom surface 319 of the male end 317 may also abut a portion of an interior of a candle holder, depending on the dimensions of the candle holder. The bottom surface 325 of the flange 320 may have an adhesive coating 330 for ensuring that the interface 300 is securely seated within the candle holder. The bottom surface 319 of the male end 317 is defined as the lowermost horizontally disposed surface of the interface 300.

FIG. 9 shows a bottom perspective view of the candle holder interface of FIG. 7. The hollow recess 318 is depicted as extending through the entire height of the interface 300. At the bottom extremity of the male end 317, a bottom surface 319 is provided. An adhesive 330 is shown extending around the circumference of the bottom surface 325 of the flange 320. The adhesive 330 may be putty, glue, bonding, cement, or a peelable sticky material for adhering the interface 300 to the interior of the candle holder. Depending on its length or width, the oil lamp base may be extended all the way through the recess, such that the base protrudes past the bottom surface 319.

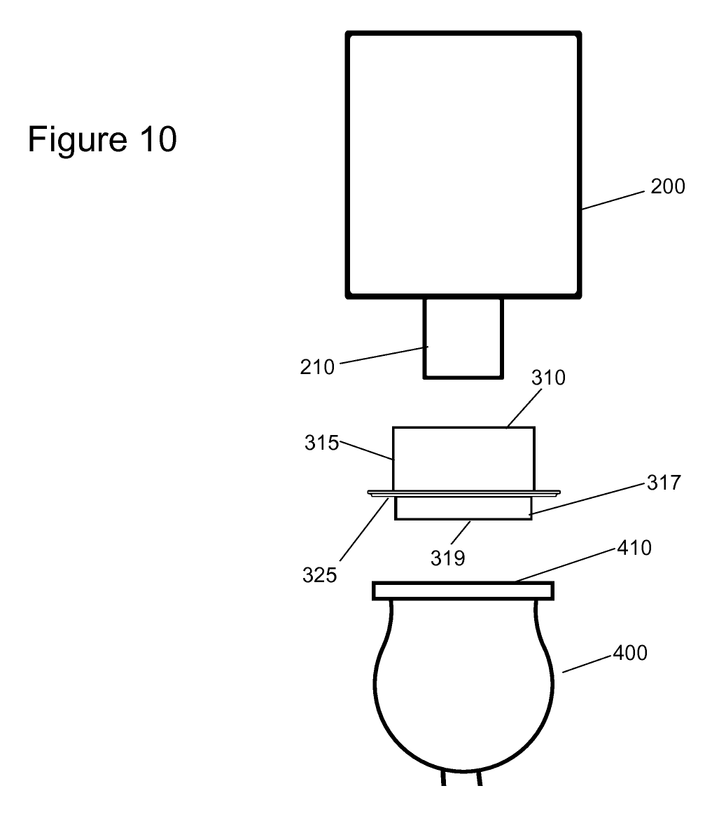

FIG. 10 shows a side elevation view of an oil lamp, a candle holder interface, and a candle holder, according to an embodiment of the disclosed technology. The view depicted in FIG. 10 represents the commencement of a method of seating the oil lamp 200 in a candle holder 400 using the candle holder interface 300. The oil lamp 200 is shown with a base portion 210 residing directly above the female end 315 of the interface 300. Likewise, the male end 317 of the interface 300 resides above the candle holder 400 into which it will be inserted.

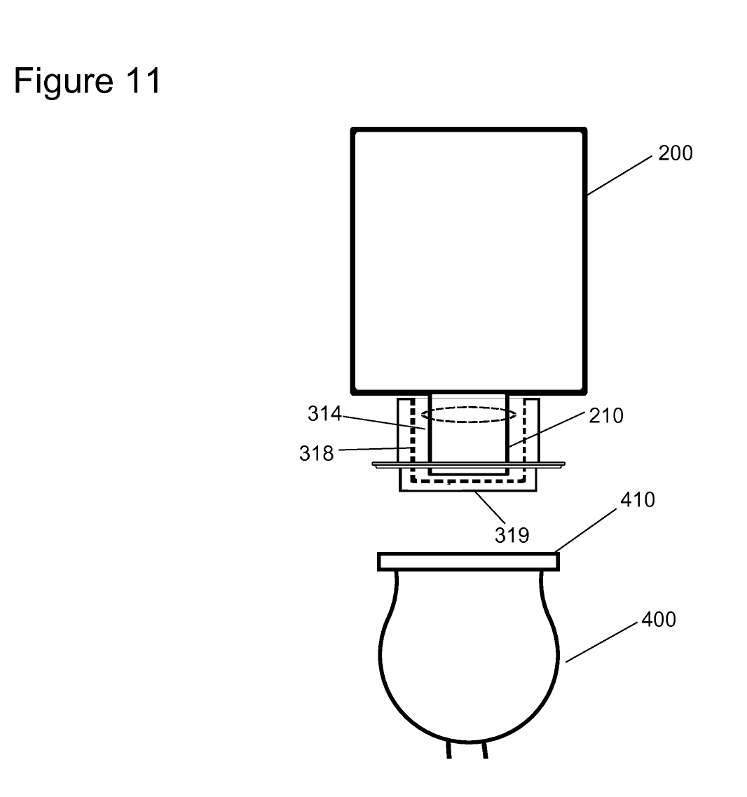

FIG. 11 shows the oil lamp inserted into the candle holder interface of FIG. 10. FIG. 11 is representative of a first step in the method of seating the oil lamp 200 in the candle holder 400. However, in other embodiments, the first step may involve inserting the candle holder interface 300 into the candle holder 400. These steps are interchangeable and may be carried out in any order. A cross-sectional view of the interface 300 is shown. The inserted base portion 210 of the oil lamp 200 abuts the interior side walls 318 of the female end 315.

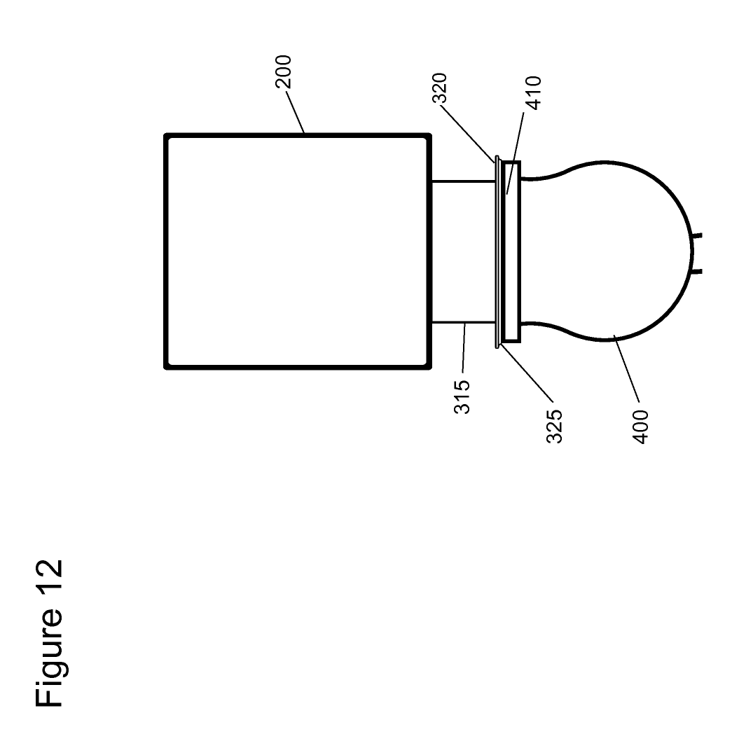

FIG. 12 shows the oil lamp and candle holder interface of FIG. 11 inserted into the candle holder. In the configuration shown in this figure, the male end 317 has been inserted into the candle holder 400. The bottom surface 325 of the flange 320 rests upon a rim 410 of the candle holder 400. The male end 317 is not visible because it is entirely enclosed within the mouth of the candle holder 400. The adhesive on the bottom surface 325 of the flange 320 sticks to the rim 410 of the candle holder 400. Thus, in the position shown, the oil lamp 200 is firmly seated within the candle holder 400 under the control of the candle holder interface 300 and the adhesive.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A candle holder interface comprising:
a substantially circular male end having an outer radius less than that of a radius of said candle holder;
a substantially circular female end disposed on a side opposite said male end, having an inner radius greater than that of a terminal receptacle adapted for being mated at a mating surface of said female end;
a circular flange situated between, and forming a unitary body with, said male end and said female end, wherein said circular flange has an outer radius greater than that of said outer radius of said male end and said outer radius of said female end.

2. The candle holder interface of claim 1, wherein said mating surface of said female end further comprises an outer lip extending above a generally flat and substantially circular said female end.

3. The candle holder interface of claim 2, wherein said mating end is flexible and frictionally engages with said terminal receptacle forming a continuous or near continuous outer surface between said outer lip and said terminal receptacle.

4. The candle holder interface of claim 3, wherein said terminal receptacle is part of an oil lamp having a male connecting end and a cylindrical oil housing, further wherein said male end frictionally engages with said female end of said candle holder interface, such that said cylindrical oil housing abuts an entire circumference of said outer lip of said candle holder interface.

5. The candle holder interface of claim 1, wherein said male end and/or bottom surface of said flange of said candle holder interface is at least partially coated with a pliable adhesive filler, wherein said candle holder interface is fixedly and removably engaged with said candle holder.

6. The candle holder interface of claim 1, wherein a portal extends through said circular male end, said female end, and said outer lip.

7. A method of placing a candle-holding receptacle into a candle holder, comprising:
receiving a base of said candle-holding receptacle into a substantially circular female end of a candle holder interface, said substantially circular female end on a side of said interface opposite a substantially circular male end on said candle holder interface with a circular flange situated between, and forming a unitary body with, said female end and said male end, wherein said circular flange has an outer radius greater than that of an outer radius of said male end and an outer radius of said female end; and
inserting said male end of said candle holder interface into a candle holder, such that said bottom surface of said flange with said adhesive abuts a rim of said candle holder.

8. The method of claim 7, further comprising a step of:
partially coating said male end and/or a bottom surface of said circular flange of said candle holder interface with a pliable adhesive filler.

9. The method of claim 7, wherein said candle-holding receptacle is forced into said candle holder interface via frictional engagement with spaced-apart projections disposed along an interior circumference of said female end.

10. The method of claim 7, wherein said candle-holding receptacle comprises a narrow base portion that is forced into said female end of said candle holder interface by way of overcoming frictional forces between said base portion and said female end of said candle holder interface.

11. The method of claim 7, wherein said step of receiving said base of said candle-holding receptacle involves wedging said base between a plurality of projections disposed within an interior portion of said female end.

12. A method of placing a candle-holding receptacle into a candle holder, comprising steps of:
receiving a base of said candle-holding receptacle into a substantially circular female end of a candle holder interface, said substantially circular female end on a side of said interface opposite a substantially circular male end on said candle holder interface;
partially coating said male end and/or a bottom surface of a circular flange of said candle holder interface with a pliable adhesive filler, said circular flange situated between, and forming a unitary body with, said female end and said male end, wherein said circular flange has an outer radius greater than that of an outer radius of said male end and an outer radius of said female end; and
inserting said male end of said candle holder interface into a candle holder, such that said bottom surface of said flange with said adhesive abuts a rim of said candle holder.
